(19) United States
(12) Patent Application Publication
(10) Pub. No.: US 2026/0178936 A1
(43) Pub. Date: Jun. 25, 2026

(54) ARTIFICIAL-INTELLIGENCE-POWERED INTEGRATION PLATFORM AS A SERVICE (IPAAS) RUNTIME IMPACT PREDICTION AND MITIGATION

(71) Applicant: BOOMI, LP, Conshohocken, PA (US)

(72) Inventors: Bradley J. DETLEFSEN, West Chester, PA (US); Michael BACHMAN, Bala Cynwyd, PA (US); Ching-Han TU, San Diego, CA (US)

(73) Assignee: BOOMI, LP, Conshohocken, PA (US)

(21) Appl. No.: 18/990,001

(22) Filed: Dec. 20, 2024

(51) Int. Cl. G06N 5/022

(52) U.S. Cl. CPC G06N 5/022

(57) ABSTRACT

It is difficult for an integration developer, especially a novice integration developer, to fully understand the impact of adding a new integration process to a runtime engine. Accordingly, disclosed embodiments may predict an impact of adding an integration process to a runtime engine using crowd-sourced historical data and generative artificial intelligence. Additional or alternative embodiments may determine a resolution to mitigate the impact of adding an integration process to a runtime engine, also using crowd-sourced historical data and generative artificial intelligence. This resolution may comprise one or more modifications to a configuration of the integration process and/or runtime engine, such as increasing the amount of a computational resource (e.g., processing power, memory, disk space, etc.) allocated to the runtime engine. Advantageously, these tools may be utilized prior to deployment of the integration process, to proactively resolve runtime issues, instead of reacting to disruptive runtime issues as they arise.

### BACKGROUND

### Field of the Invention

The embodiments described herein are generally directed to Integration Platform as a Service (iPaaS) and artificial intelligence (AI), and, more particularly, to AI-powered iPaaS runtime impact prediction and mitigation.

### Description of the Related Art

Integration Platform as a Service (iPaaS) enables the integration of applications and data. The iPaaS platform provided by Boomi® of Conshohocken, Pennsylvania, enables users to construct integration processes from pre-built steps, visually represented as “shapes,” which each has a set of configuration properties. Each step dictates how an integration process retrieves data, manipulates data, routes data, sends data, and/or the like. These steps can be connected together in endless combinations to build simple to very complex integration processes.

One or more integration processes, developed in this manner, are executed on the iPaaS platform using a set of computational resources, known as a runtime engine. Even if the runtime engine is built on a virtual system, these computational resources rely on physical resources, and therefore, are finite. Thus, each runtime engine is allocated a fixed set of computational resources. As a result, a runtime engine cannot simply execute any integration process of any size. The runtime engine may reach the limit of any given computational resource (e.g., processing power, memory, disk space, etc.) independently of other computational resources. The limit(s) may be reached on an occasional basis (e.g., at peak integration load) or a regular basis (e.g., due to an extended regular integration load). When a limit is reached, the runtime engine may experience a deterioration in performance, including, for example, slowness, crashes, errors, contention between integration processes for the finite computational resources of the runtime engine, and/or the like.

Ideally, a user would know the precise set of computational resources required by a runtime engine. However, when a new integration process is deployed to a target runtime engine, it is rare for the user to fully understand the potential impact that the integration process will have on that runtime engine. Traditionally, the user must rely on a combination of general recommendations and human knowledge and experience, to determine whether or not the runtime engine can sufficiently handle the new load. Without a full understanding, the deployment of the new integration process to the runtime engine may cause significant deterioration in the performance of the runtime engine. Thus, the user is forced to react to these issues, as they arise, post-deployment, which may cause significant disruptions to operations.

### SUMMARY

Accordingly, systems, methods, and non-transitory computer-readable media are disclosed for AI-powered iPaaS runtime impact prediction and mitigation.

In an embodiment, a method comprises using at least one hardware processor to, prior to deployment of an integration process to a runtime engine, perform impact prediction comprising: acquiring integration data for the integration process and runtime data for the runtime engine, wherein the integration data comprise an integration configuration and integration load for the integration process, and wherein the runtime data comprise a runtime configuration and runtime load for the runtime engine; generating a first prompt based on the integration data and the runtime data; applying a first generative model to the first prompt to generate a first response comprising an impact to the runtime engine of adding the integration process to the runtime engine; and outputting a first visual representation of the impact within a graphical user interface. The first generative model may comprise a large language model.

The method may further comprise using the at least one hardware processor to, after performing the impact prediction, perform impact mitigation comprising: generating a second prompt based on the integration data and the runtime data; applying a second generative model to the second prompt to generate a second response comprising a resolution for the impact; and outputting a second visual representation of the resolution within the graphical user interface. The second generative model may comprise a large language model. The first generative model and the second generative model may be a same model. The second visual representation of the resolution may comprise a list of one or more modifications to one or both of the integration process or the runtime engine. The graphical user interface may comprise a first input for activating the impact mitigation, wherein the impact mitigation is performed in response to selection of the first input.

The impact mitigation may further comprise modifying one or both of the integration process and the runtime engine according to the resolution. The graphical user interface may comprise a second input for implementing the resolution, wherein the modification of one or both of the integration process and the runtime engine is performed in response to selection of the second input. The modification of one or both of the integration process and the runtime engine may comprise modifying a configuration of the runtime engine. Modifying the configuration of the runtime engine may comprise increasing an amount of at least one computational resource allocated to the runtime engine. The at least one computational resource may comprise one or more of processing power, memory, disk space, or bandwidth.

Generating the first prompt, based on the integration data and the runtime data, may comprise: generating at least one embedding vector from the integration data and the runtime data; searching a vector database for one or more matching embedding vectors that match the at least one embedding vector, according to a similarity metric, wherein the vector database comprises a plurality of embedding vectors, and wherein each of the plurality of embedding vectors represents a position of a past entity in a multi-dimensional vector space, wherein the past entity is one or both of a historical integration process or a historical runtime. The plurality of embedding vectors may be generated from crowd-sourced historical data using a vector embedding model. The multi-dimensional vector space may comprise at least one-hundred dimensions. The at least one embedding vector may comprise an embedding vector for each lineage in the integration process, wherein each lineage represents a single path through the integration process.

The first visual representation may comprise an overall impact. The first visual representation may further comprise one or more potential errors.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 illustrates an example data flow for AI-powered iPaaS runtime impact prediction and mitigation, according to an embodiment;

FIG. 4 illustrates a process for AI-powered iPaaS runtime impact prediction and mitigation, according to an embodiment; and

FIGS. 5A-5F illustrate a graphical user interface, according to an embodiment.

### DETAILED DESCRIPTION

In an embodiment, systems, methods, and non-transitory computer-readable media are disclosed for AI-powered iPaaS runtime impact prediction and mitigation. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims. Also, as used herein, a reference numeral with an appended letter will be used to refer to a specific component, whereas the same reference numeral without any appended letter will be used to refer collectively to a plurality of the component or to refer to a generic or arbitrary instance of the component.

### 1. Infrastructure

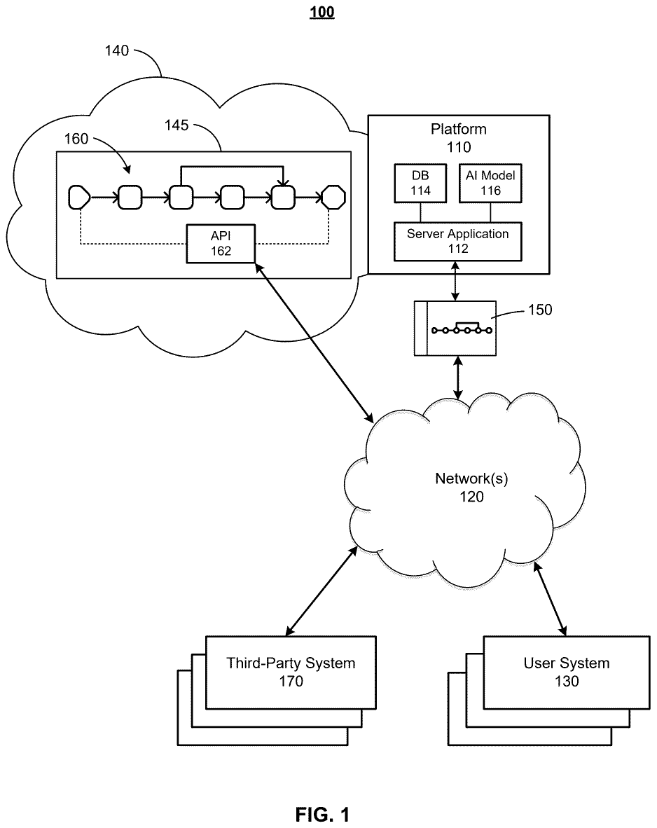

FIG. 1 illustrates an example infrastructure 100, in which one or more of the processes described herein may be implemented, according to an embodiment. Infrastructure 100 may comprise a platform 110 which hosts and/or executes one or more of the disclosed processes, which may be implemented in software and/or hardware. In particular, platform 110 may execute a server application 112, host a database 114 that may store data used by server application 112, and/or execute an artificial intelligence (AI) model 116 that may process data generated by server application 112 and/or stored in database 114 and/or generate data for use by server application 112 and/or storage in database 114. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed.

Platform 110 may be communicatively connected to one or more networks 120. Network(s) 120 enable communication between platform 110 and user system(s) 130. Network(s) 120 may comprise the Internet, and communication through network(s) 120 may utilize standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to a plurality of user systems 130 through a single set of network(s) 120, it should be understood that platform 110 may be connected to different user systems 130 via different sets of one or more networks. For example, platform 110 may be connected to a subset of user systems 130 via the Internet, but may be connected to another subset of user systems 130 via an intranet.

While only a few user systems 130 are illustrated, it should be understood that platform 110 may be communicatively connected to any number of user system(s) 130 via network(s) 120. User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would be the personal or professional workstation of an integration developer that has a user account for accessing server application 112 on platform 110. It should be understood that the integration developer may be anywhere from a novice user, with little to no prior experience in integration development, to an expert user, with many years of experience in integration development. When platform 110 is an iPaaS platform, each user account may be associated with an overarching organizational account for managing an integration platform on the iPaaS platform.

Server application 112 may manage an integration environment 140. In particular, server application 112 may provide a user interface 150 and backend functionality, including one or more of the processes disclosed herein, to enable users, via user systems 130, to construct, develop, modify, save, delete, test, deploy, un-deploy, and/or otherwise manage integration processes 160 within integration environment 140. User interface 150 may comprise a graphical user interface that implements a low-code environment, including potentially a no-code environment, in which users may construct integration processes 160.

The user of a user system 130 may authenticate with platform 110 using standard authentication means, to access server application 112 in accordance with permissions or roles of the associated user account. The user may then interact with server application 112 to manage one or more integration processes 160, for example, within a larger integration platform within integration environment 140. It should be understood that multiple users, on multiple user systems 130, may manage the same integration process(es) 160 and/or different integration processes 160 in this manner, according to the permissions or roles of their associated user accounts.

Although only a single integration process 160 is illustrated, it should be understood that, in reality, integration environment 140 may comprise any number of integration processes 160. In an embodiment, integration environment 140 supports integration platform as a service (iPaaS). In this case, integration environment 140 may comprise one or a plurality of integration platforms that each comprises one or a plurality of integration processes 160. Thus, it should be understood that integration environment 150 could comprise hundreds, thousands, millions, billions, or more integration processes 160. Each integration platform may be associated with an organization, which may be associated with one or more user accounts by which respective user(s) manage the organization's integration platform, including the various integration process(es) 160 on the organization's integration platform.

An integration process 160 may represent a transaction involving the integration of data between two or more systems, and may comprise a series of elements that specify logic and transformation requirements for the data to be integrated. Each element, which may also be referred to herein as a “step” and have a visual representation referred to herein as a “shape,” may transform, route, and/or otherwise manipulate data to attain an end result from input data. For example, a basic integration process 160 may receive data from one or more data sources (e.g., via an application programming interface 162 of the integration process 160), manipulate the received data in a specified manner (e.g., including mapping, analyzing, normalizing, altering, updating, enhancing, and/or augmenting the received data), and send the manipulated data to one or more specified destinations (e.g., via an application programming interface of each destination). An integration process 160 may represent a business workflow or a portion of a business workflow or a transaction-level interface between two systems, and comprise, as one or more elements, software modules that process data to implement the business workflow or interface. A business workflow may comprise any myriad of workflows of which an organization may repetitively have need. For example, a business workflow may comprise, without limitation, procurement of parts or materials, manufacturing a product, selling a product, shipping a product, ordering a product, billing, managing inventory or assets, providing customer service, ensuring information security, marketing, onboarding or offboarding an employee, assessing risk, obtaining regulatory approval, reconciling data, auditing data, providing information technology services, and/or any other workflow that an organization may implement in software.

The functionality of server application 112 may include a process for constructing an integration process 160 within one or more screens of a graphical user interface of user interface 150. Embodiments of such functionality are disclosed, for example, in U.S. Pat. No. 8,533,661, issued on Sep. 10, 2013, and U.S. Pat. No. 11,886,965, issued on Jan. 30, 2024, which are both hereby incorporated herein by reference as if set forth in full, and referred to hereafter as “the GUI applications.” In particular, the GUI applications describe functionality that enable the construction of integration processes 160 on a virtual canvas.

Once an integration process 160 has been constructed, it may be deployed to a production environment within integration environment 140. In particular, the user may deploy the new integration process 160 to a runtime engine 145 within integration environment 140. However, the user may not have a complete understanding of how deployment of the constructed integration process 160 will impact runtime engine 145, which may comprise one or more other integration processes 160. Deployment of the new integration process 160 may result in a deterioration in the performance of runtime engine 145, such as slowness, crashes, errors, contention, and/or the like. Accordingly, disclosed embodiments utilize AI model 116 to predict the impacts of integration processes 160 on runtime engines 145, such that users are well informed prior to deployment of their integration processes 160, and/or proactively mitigate these impacts prior to deployment of their integration processes 160.

Each integration process 160, when deployed, may be communicatively coupled to network(s) 120. For example, each integration process 160 may comprise an application programming interface (API) 162 that enables clients to access integration process 160, for example, via network(s) 120. A client may push data to integration process 160 through application programming interface 162, and/or pull data from integration process 160 through application programming interface 162.

One or more third-party systems 170 may be communicatively connected to network(s) 120, such that each third-party system 170 may communicate with an integration process 160 in integration environment 140 via application programming interface 162. Third-party system 170 may host and/or execute a software application that pushes data to integration process 160 and/or pulls data from integration process 160, via application programming interface 162. Additionally or alternatively, an integration process 160 may push data to a software application on third-party system 170 and/or pull data from a software application on third-party system 170, via an application programming interface of the third-party system 170. Thus, third-party system 170 may be a client or consumer of one or more integration processes 160, a data source for one or more integration processes 160, and/or the like. As examples, the software application on third-party system 170 may comprise, without limitation, enterprise resource planning (ERP) software, customer relationship management (CRM) software, accounting software, and/or the like.

### 2. Example Processing System

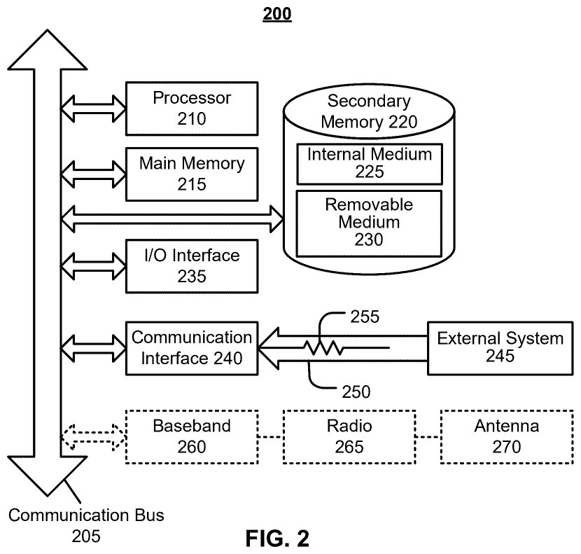

FIG. 2 illustrates an example processing system, by which one or more of the processes described herein may be executed, according to an embodiment. For example, system 200 may be used to store and/or execute server application 112, and/or may represent components of platform 110, user system(s) 130, third-party system 170, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, any of the processors available from Nvidia Corporation of Santa Clara, California, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Examples of input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch-panel display (e.g., in a smartphone, tablet computer, or other mobile device).

System 200 may comprise a communication interface 240. Communication interface 240 allows software to be transferred between system 200 and external devices, networks, or other information sources. For example, computer-executable code and/or data may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enables system 200 to perform one or more of the various processes disclosed herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, may cause processor 210 to perform one or more of the various processes disclosed herein.

System 200 may optionally comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, baseband system 260 decodes the signal and converts it to an analog signal. Then, the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 may be communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform one or more of the various processes disclosed herein.

### 3. Data Flow

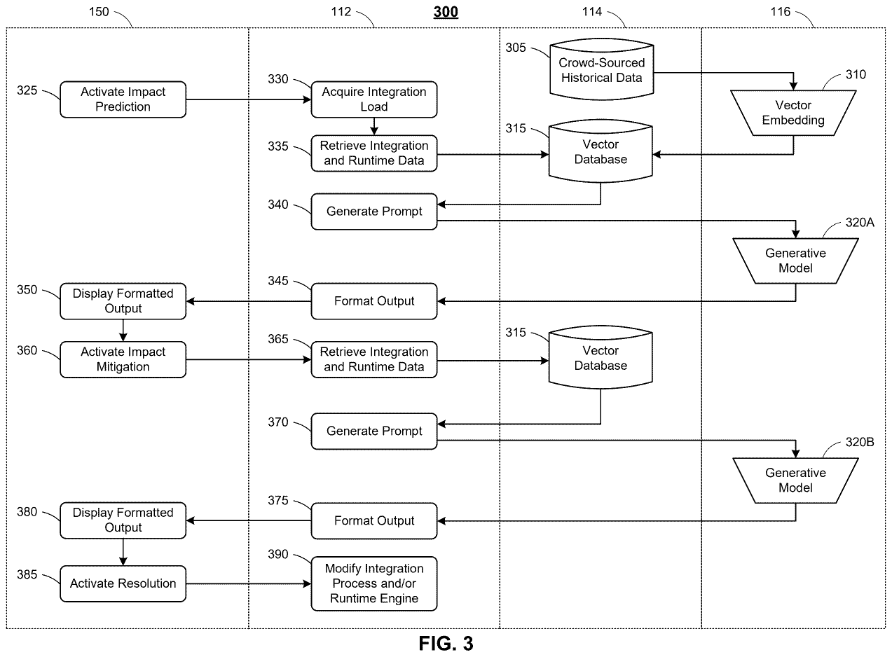

FIG. 3 illustrates an example data flow 300 for AI-powered iPaaS runtime impact prediction and mitigation, according to an embodiment. In data flow 300, user interface 150 may implement modules 325, 350, 360, 380, and 385, server application 112 may implement modules 330, 335, 340, 345, 365, 370, 375, and 390, database 114 may store crowd-sourced historical data 305 and vector database 315, and AI model 116 may comprise vector embedding model 310 and generative model(s) 320 (e.g., illustrated as 320A and 320B). Modules 325, 330, 335, 340, 345, 350, 360, 365, 370, 375, 380, 385, and 390 and models 310 and 320 are preferably implemented as software modules, but could also be implemented as hardware modules or as modules comprising a combination of hardware and software.

Modules 325-350 represent an impact-prediction tool for predicting the impact of adding a specific integration process 160 to a specific runtime engine 145, and modules 360-390 represent an impact-mitigation tool for mitigating the impact of adding the specific integration process 160 to the specific runtime engine 145. Although the impact-prediction tool and impact-mitigation tool are illustrated in combination, alternative embodiments of data flow 300 may implement only the impact-prediction tool (i.e., without the impact-mitigation tool) or only the impact-mitigation tool (i.e., without the impact-prediction tool). In other words, each of the impact-prediction and impact-mitigation tools may be implemented as an independent tool, in isolation or in combination with one or more other tools.

Initially, platform 110 may store (e.g., in database 114) crowd-sourced historical data 305. Crowd-sourced historical data 305 may comprise a plurality of integration data and/or a plurality of runtime data. Crowd-sourced historical data 305 may be crowd-sourced from a plurality of integration platforms managed through platform 110, which may be an iPaaS platform, such as the Boomi® iPaaS platform. Each instance of integration data may represent an integration process 160 on one of the plurality of integration platforms, and each instance of runtime data may represent a runtime engine 145 on one of the plurality of integration platforms. The iPaaS platform may support a plurality of integration platforms, each managed by a different organizational account that is associated with one or more user accounts. Thus, crowd-sourced historical data 305 will primarily represent integration processes 160 and runtime engines 145 developed by other users for other organizations, but could also represent integration processes 160 and runtime engines 145 developed by the same user or developed by another user for the same organization. In any case, crowd-sourced historical data 305 may represent a massive repository (e.g., thousands, tens of thousands, hundreds of thousands, millions, tens of millions, hundreds of millions, billions, tens of billions, hundreds of billions, or more integration configurations) of previously executed integration processes 160 and runtime engines 145. This repository will generally be very diverse in terms of structures, configurable parameter values, applications, inputs and outputs, and the like, and potentially crowd-sourced from a diverse group of different organizations. Crowd-sourced historical data 305 may be anonymized or deidentified to remove any personally identifiable information (PII) or other confidential or sensitive information.

Each instance of integration data, within crowd-sourced historical data 305, may comprise the configuration of an integration process 160 and the integration load for that integration process 160. The configuration of an integration process 160 may comprise the structure of the integration process 160, the value(s) of any configurable or fixed parameters of the integration process 160, and/or the like. The integration load of an integration process 160 may comprise the execution method (e.g., real-time, scheduled, manual, etc.), execution frequency (e.g., a time interval on the order of seconds, minutes, hours, days, etc., a number of executions per a given time period, etc.), throughput (e.g., amount of data processed by integration process 160 within a given time period), average document size (e.g., amount of data in each input to integration process 160), and/or the like, for the integration process 160.

To aid in the comparison of integration processes 160 to each other, the structure of each integration process 160 may be represented as one or more lineages. As used herein, the term “lineage” refers to a path through an integration process 160. In an embodiment, each lineage consists of the sequence of steps (e.g., represented as step identifiers) in a single path through an integration process 160. For example, an integration process 160 may comprise a decision step with two branches. In this case, there would be at least two paths through the integration process 160, corresponding to each branch. It should be understood that an integration process 160 with no decision steps may have only a single path, and that an integration process 160 with a plurality of decision steps or a decision step with three or more branches may comprise three or more paths. Thus, an integration process 160 may consist of any number of paths. Each path through an integration process 160 may be represented as a single lineage, such that the structure for an integration process 160 with a single path will consist of a single lineage, and the structure for an integration process 160 with a plurality of paths will consist of a plurality of lineages, with a one-to-one correspondence between paths and lineages. Lineages and their representations are discussed in more detail in U.S. Pat. No. 11,886,965, issued on Jan. 30, 2024, which is hereby incorporated herein by reference as if set forth in full. Advantageously, the utilization of lineages enable the disclosed artificial intelligence to have “awareness” of integrations.

Each instance of runtime data, within crowd-sourced historical data 305, may comprise the configuration of a runtime engine 145 and the runtime load for that runtime engine 145. The configuration of a runtime engine 145 may comprise the structure of the runtime engine 145, the software version of the runtime engine 145, the integration process(es) 160 contained within the runtime engine 145, and/or the like. The structure of a runtime engine 145 may comprise the available computational resources, such as the amount of processing power, memory (e.g., RAM), disk space, bandwidth, and/or other computational resources allocated to the runtime engine 145. The runtime load of a runtime engine 145 may comprise the execution method, execution frequency, throughput, document sizes being processed, and/or the like, for the runtime engine 145. It should be understood that the runtime load of a runtime engine 145 may be a function (e.g., sum) of the integration loads for all integration processes 160 executing within that runtime engine 145.

Crowd-sourced historical data 305 may be fed through a vector embedding model 310 to generate at least one embedding vector for each integration process 160 and/or for each runtime engine 145 represented in crowd-sourced historical data 305. In the case of integration processes 160, an embedding vector may be generated for each lineage in each integration process 160 (i.e., wherein each lineage represents a single path through integration process 160), such that a single integration process 160 with multiple lineages will have multiple embedding vectors. The embedding vector for an integration process 160 may be generated from a set of features that are derived from the integration configuration (e.g., structure, parameters, etc.) of the integration process 160 and/or the integration load of the integration process 160. Similarly, the embedding vector for a runtime engine 145 may be generated from a set of features that are derived from the configuration (e.g., structure, software version, contained integration processes 160) of the runtime engine 145 and/or the runtime load of the runtime engine 145. In an embodiment, a single embedding vector is generated for a combination of an integration process 160 and the runtime engine 145 in which that integration process 160 executed. In this case, the embedding vector may be generated from a set of features that are derived from the respective integration configuration, integration load, runtime configuration, and runtime load. Alternatively or additionally, the embedding vector may be generated from a set of features derived from other relevant data.

Vector embedding model 310 encodes the features of an entity (i.e., integration process 160 and/or runtime engine 145) into a multi-dimensional embedding vector that effectively captures important semantics and other characteristics, including, for example, dimensionality, sparsity, support for data types (e.g., text, image, audio, etc.), similarity, indexing (e.g., inverted file (IVF), hierarchical navigable small worlds (HNSW), etc.), scalability, query performance, retrieval speed, data normalization, metadata association, support for real-time updates, support for batch processing, integration with machine-learning models or other artificial intelligence, support for multi-modal data, performance under load (e.g., concurrency), storage efficiency, redundancy management, fault tolerance, access control, ease of integration with existing systems, and/or the like. Each embedding vector represents the position of the corresponding entity, whether an integration process 160 and/or runtime engine 145, within a multi-dimensional vector space. The multi-dimensional vector space may comprise one-hundred or more dimensions. The embedding vector for an entity will comprise a value (e.g., real value) for the entity, for each dimension of the vector space, with each value representing a position of the entity within the respective dimension. Any suitable vector embedding model 310 may be used, including, without limitation, Word2Vec, Global Vectors for Word Representation (GloVe), FastText, Embeddings from Language Models (ELMo), Bidirectional Encoder Representations from Transformers (BERT), Dense Passage Retrieval (DPR), Universal Sentence Encoder (USE), or the like.

The embedding vectors for integration processes 160 may be generated by a first vector embedding model 310 for a first vector space, and the embedding vectors for runtime engines 145 may be generated by a second vector embedding model 310, that is different from the first vector embedding model 310, for a second vector space that is different from the first vector space. Alternatively, the embedding vectors for integration processes 160 and runtime engines 145 may be generated by the same vector embedding model 310 for the same vector space. In yet another alternative embodiment, an embedding vector may be generated for each integration process 160 in each runtime engine 145, such that each embedding vector represents a specific integration process 160 (e.g., specific lineage of a specific integration process 160) in a specific runtime engine 145. In this case, the set of features used by vector embedding model 310 to generate each embedding vector may derived from the configuration (e.g., structure, parameters, etc.) of the integration process 160, the integration load of the integration process 160, the configuration of the runtime engine 145 in which the integration process 160 executes, and/or the runtime load of the runtime engine 145 in which the integration process 160 executes. It should be understood that, in this embodiment, all embedding vectors will be generated by the same vector embedding model 310 for the same vector space.

The embedding vectors, generated by vector embedding model 310, may be stored in a vector database 315. In an embodiment in which the embedding vectors for integration processes 160 are generated by a different vector embedding model 310 for a different vector space than the embedding vectors for runtime engines 145, vector database 315 may comprise a first vector database for integration processes 160 and a second vector database for runtime engines 145. Otherwise, in an embodiment in which the embedding vectors for integration processes 160 and runtime engines 145 reside in the same vector space or embedding vectors are generated for the combination of integration processes 160 and their corresponding runtime engines 145, vector database 315 may consist of a single, unified vector database.

In any case, embedding vectors in vector database 315 may be clustered, according to a similarity metric (e.g., cosine similarity), and/or searched for the nearest neighbor(s) to an embedding vector in a search query, according to the similarity metric. The use of vector embedding model 310 to embed entities into a vector space enables efficient management of diverse data samples by leveraging encoding and similarity assessments to identify integration processes 160 and/or runtime engines 145 that match (e.g., are identical or similar to) an integration process 160 and/or runtime engine 145 in a query.

Each of the plurality of embedding vectors in vector database 315 may be associated with information about the entity (i.e., integration process 160 and/or runtime engine 145) represented by that embedding vector. Thus, the information associated with an embedding vector may be retrieved, along with the embedding vector from vector database 315. This associated information may comprise the configuration and/or load of the respective entity, as well as an execution history and/or modification history for that entity. It should be understood that the associated information may also comprise additional data.

The execution history for an entity may comprise any execution events that represent a performance of the entity. Examples of such execution events include, without limitation, crashes (e.g., entity stopped working entirely, forcing a restart), errors (e.g., entity experienced partial or complete failure during execution), contention (e.g., integration processes 160 in the same runtime engine 145 are unable to execute because of self-preserving behavior, such as preventing or canceling executions and rejecting executions, as in the case of real-time listeners), and/or the like. An execution event may also comprise a measurement of a performance metric, such as computational speed, data throughput, the utilization of allocated computational resources (e.g., processing power, memory, disk space, bandwidth, etc.), and/or the like. In this case, the value of each performance metric may be measured at fixed time intervals, such that the change in any given performance metric may be calculated over time. An execution event could also comprise an indication of successful operation of the entity. Each execution event for an entity may be associated with a timing that indicates the chronology of the execution event, relative to other execution events for the same entity.

The modification history for an entity may comprise any modifications to the configuration of the entity. Such a modification may include a change to the structure of an integration process 160, a change to the value of each of one or more parameters of an integration process 160, a change to the structure of a runtime engine 145 (e.g., increasing the allocated processing power, memory, disk space, bandwidth, and/or other computational resources), un-deployment of an integration process 160 from a runtime engine 145, and/or the like.

For any given entity, a resolution to a deterioration in performance of that entity may be determined from the execution history and the modification history. In particular, it can be inferred that a modification that is within a time period following an execution event, representing a deterioration in the performance of the entity, and within a time period preceding a reversal of that deterioration in performance, caused the improvement in performance. For example, if a first execution event represents a deterioration in a performance metric, relative to a prior execution event, and a second execution event, which is subsequent to the first execution event, represents an improvement in that performance metric, an intervening modification (i.e., between the first execution event and the second execution event) may be inferred to have caused the improvement in performance, provided that the timing between the first execution event, the modification, and the second execution event can support such an inference. Similarly, if the execution events comprise a cluster of crashes, followed by a long period of no crashes, and the modification history comprises a modification between the cluster of crashes and the long period of no crashes, it may be inferred that the modification resolved the crashes. In an embodiment, the value of each configurable parameter could be plotted over time, using the modification history, alongside the execution events from the execution history, to determine the best configurations to avoid negative execution events, such as slowness, crashes, errors, contention, and/or the like.

Module 325 may activate the impact-prediction tool. In particular, the impact-prediction tool may be triggered from a graphical user interface within user interface 150. Initially, the user may construct an integration process 160 within the graphical user interface. For example, the graphical user interface may comprise a virtual canvas on which a user may drag and drop and connect shapes, representing steps that perform specific functions within an integration process 160. Thus, the user may intuitively construct an integration process 160 by simply placing shapes on the virtual canvas and connecting those shapes together, to define data flows between the steps represented by those shapes. After completing the construction of integration process 160, the user may select an input, within the graphical user interface, that triggers module 325, which activates the impact prediction for the constructed integration process 160. Ideally, the impact prediction is performed prior to deployment of integration process 160 to a runtime engine 145.

Module 330 may acquire the expected integration load for the integration process 160 that is the subject of the impact prediction. The integration load may comprise any information that relates to how much load integration process 160 will add to a runtime engine 145. In an embodiment, the integration load for the integration process 160, which is the subject of the impact prediction, comprises a value for each of the same fields that were included within the integration loads for integration processes 160 in crowd-sourced historical data 305. Examples of these fields include, without limitation, execution method, execution frequency, throughput, document sizes being processed, and/or the like. It should be understood that, since integration process 160 has not yet been added to a runtime engine 145, some of this information may not be precisely known. In this case, the integration load may comprise expected or predicted values for these fields.

Module 330 may acquire the integration load by prompting the user (e.g., via a pop-up dialog frame in the graphical user interface) to enter the value for each field via one or more inputs. The values may be entered in any manner, including from drop-down menus, as numerical values, and/or the like. However, in a preferred embodiment, at least a subset, if not all, of the values for the fields in the integration load may be input into a textbox using natural language. In this case, the input may be converted into a value for each field using natural-language processing (NLP), including, potentially, feeding each input for a field to a large language model to derive the value of that field. As used herein, the term “natural language” or “natural-language” refers to language, including grammar, that would be expected in a normal conversation between two humans. The ability for users to enter the field values of the integration load using natural language may provide flexibility in how the fields are defined, which may facilitate utilization of the impact-prediction tool, especially by novice users.

Module 330 may also acquire the specific runtime engine 145 to which the integration process 160, which is the subject of the impact prediction, is to be added. The specific runtime engine 145 may be selected by a user (e.g., from a drop-down menu) from the set of available runtime engines 145 (e.g., the set of runtime engines 145 that are currently active or executing on the user's integration platform). This selection may occur in the same dialog frame into which the field values of the integration load are input.

Module 335 may retrieve integration data for the integration process 160 and runtime data for the runtime engine 145 that are the subjects of the impact prediction. It should be understood that this integration process 160 may be the integration process 160 that was constructed in the graphical user interface, and this runtime engine 145 will be the runtime engine 145 that was acquired by module 330. The integration data may comprise the configuration of integration process 160, as well as the integration load acquired by module 330. It should be understood that the integration load is similar to, and may comprise the same fields as, the integration load for each integration process 160 represented in crowd-sourced historical data 305, but will represent expected load, rather than actual historical load. The runtime data may comprise the configuration of the runtime engine 145 and the current runtime load for that runtime engine 145. Again, it should be understood that the runtime load may be similar to, and may comprise the same fields as, the runtime load for each runtime engine 145 represented in crowd-sourced historical data 305, but will represent current load, rather than historical load.

The impact-prediction tool may utilize a retrieval-augmented generation (RAG) architecture. The RAG architecture combines a retrieval-based component with a generation-based component. It is particularly effective when a response is to be informed by a large knowledge base. In this case, the knowledge base comprises vector database 315, which supports the retrieval-based component, and a generative model 340A, which supports the generation-based component. The RAG architecture provides dynamic and scalable access to the knowledge base, improved generalization (e.g., enabling generative model 340A to respond to prompts beyond those for which generative model 340A was trained), and reduced model size (e.g., since generative model 340A does not need to store all relevant data internally). Suitable enhancements to the RAG architecture, which may be used, include Chunked RAG (CRAG), in which the retrieval-based component retrieves relevant chunks of the knowledge corpus, and Self-RAG, in which the retrieval-based component is able to retrieve relevant data from a store of prior responses, as well as vector database 315. In an alternative embodiment, the impact-prediction tool may comprise only the retrieval-based component or only the generation-based component.

Firstly, in the retrieval-based component, server application 112 retrieves relevant data from vector database 315, to provide a factual grounding for the generation-based component. To this end, server application 112 may generate at least one embedding vector for the integration process 160 and runtime engine 145. Each such embedding vector represents the position of the entity, whether integration process 160 and/or runtime engine 145, within the same multi-dimensional vector space as the embedding vectors in vector database 315. Thus, each embedding vector will comprise a value (e.g., real value) for the entity, for each dimension of the vector space, with each value representing a position of the entity within the respective dimension.

It should be understood that each embedding vector may be generated using vector embedding model 310, in the same manner as the embedding vectors in vector database 315 were generated from crowd-sourced historical data 305 using vector embedding model 310. Thus, the same set of features that were derived from integration processes 160 and runtime engines 145, in crowd-sourced historical data 305, will be derived from the integration process 160 and runtime engine 145 that are the subject of the impact prediction. However, it should be understood that, in this case, the integration load may be an expected integration load, rather than an actual historical integration load, and the runtime load may include a current runtime load, rather than only a historical runtime load. In addition, if the integration processes 160 and runtime engines 145, from crowd-sourced historical data 305, are embedded into two separate vector spaces in vector database 315, the integration process 160 and runtime engine 145, which are the subject of the impact prediction, will also be embedded into those two same vector spaces. On the other hand, if the integration processes 160 and runtime engines 145, from crowd-sourced historical data 305, are embedded into a single vector space in vector database 315, either as two separate embedding vectors or a single embedding vector, the integration process 160 and runtime engine 145, which are the subject of the impact prediction, will also be embedded into that single vector space, either as two separate embedding vectors or a single embedding vector. Furthermore, if the integration process 160, which is the subject of the impact prediction, contains a plurality of lineages, an embedding vector may be generated for each of the plurality of lineages (i.e., wherein each lineage represents a single path through integration process 160), to produce a plurality of embedding vectors.

Server application 112 may then search vector database 315 for one or more of the plurality of embedding vectors that match the embedding vector(s) generated for the integration process 160 and/or runtime engine 140, which are the subject of the impact prediction, according to a similarity metric (e.g., the most similar embedding vector or a plurality of the most similar embedding vectors). Any suitable similarity metric may be used. As an example, the similarity metric may be a distance, such as Euclidean distance, Manhattan distance, Cosine distance, Hamming distance, Minkowski distance, Chebyshev distance, Jaccard distance, Haversine distance, Sorensen-Dice distance, or the like. The search of vector database 315 may be performed using any suitable technique, such as brute force, k-dimensional trees, ball trees, locality-sensitive hashing (LSH), k-nearest neighbor (kNN), approximate nearest neighbor (e.g., Facebook™ AI Similarity Search, Approximate Nearest Neighbors Oh Yeah (ANNOY), scalable nearest neighbors (ScaNN), etc.), Hierarchical Navigable Small World (HNSW) graphs, Voronoi diagrams, vector quantization, product quantization (PQ), random projection trees, lattice-based methods (e.g., cover tree, vantage point tree, etc.), and/or the like.

The search of vector database 315 may return the single most similar embedding vector, or a plurality of the most similar embedding vectors (e.g., k nearest neighbors, a nearest cluster of embedding vectors, etc.), as determined by the similarity metric. In an embodiment that returns a plurality of the most similar embedding vectors, the plurality of most similar embedding vectors may be a predefined number (e.g., three, five, ten, etc.) of the most similar embedding vectors, every embedding vector for which the similarity metric satisfies (e.g., is greater than or equal to) a predefined threshold, and/or the like. Server application 112 may also retrieve the information associated with each embedding vector, in the returned set of one or more embedding vectors, including the execution history and/or modification history associated with the entity represented by the embedding vector. It should be understood that, in some cases, vector database 315 may return no embedding vectors (e.g., no similarity metric satisfies the predefined threshold).

Secondly, in the generation-based component, server application 112 applies generative model 320A, which may be a generative language model (e.g., large language model), to the associated information retrieved for each matching embedding vector, including the execution history associated with each matching embedding vector. Generative model 320A may be fine-tuned to weight this associated information as more important than other data (e.g., internal to generative model 320A). This associated information, along with a relevant query, may be embodied in a textual prompt that is generated by module 340. This prompt is input to generative model 320A to produce a response. In particular, generative model 320A processes the prompt to produce a contextually aware response, where the context may comprise at least the execution histories of similarly configured integration processes 160 and runtimes 145.

Module 340 may generate the prompt for generative model 320A based on the result of the search of vector database 315 in the retrieval-based component. The prompt may be generated by inserting relevant data consisting of, comprising, or otherwise derived from the retrieved information that is associated with each matching embedding vector, including at least a portion of the execution history, into a predefined template. The predefined template may comprise a pre-conversation and/or post-conversation, which provide context and/or instructions for generative model 320A, and one or more placeholders into which the relevant data are inserted. The pre-conversation and/or post-conversation may define the role of generative model 320A, which may include instructing generative model 320A to determine the impact (e.g., an overall impact and/or any errors that may potentially result) of adding integration process 160 to runtime engine 145, based on the relevant data, which may include a representation of load and/or execution history for each of one or more integration processes 160 and/or runtimes 145 that have similar configurations to the integration process 160 and/or runtime 145, respectively, which are the subject of the impact prediction. The pre-conversation and/or post-conversation may also define an output format for generative model 320A (e.g., a list structure, a hierarchical structure, a markup-language structure, etc.), and/or perform other functions. Generative model 320A may return a response that provides an overall impact, along with any potential errors that may result, from adding integration process 160 to runtime engine 145. For instance, the overall impact could identify the highest risks of deploying integration process 160 to runtime engine 145 (e.g., at some level of 3+ sigma distribution, which may be hard-coded or adaptive if peak load occurs for all integration processes 160 in runtime engine 145). It should be understood that, in some cases, there may be no negative impact from adding integration process 160 to runtime engine 145 (e.g., because runtime engine 145 has sufficient resources to accommodate the additional load from integration process 160), in which case, the response from generative model 320A may indicate that there is no negative impact. The response may also identify configurations of the most similar integration process 160 and/or runtime engines 145, identified from vector database 315.

Generative model 320A may comprise or consist of a generative language model. The generative language model may comprise or consist of a large language model, such as the Generative Pre-trained Transformer (GPT). GPT-4 is the fourth-generation language prediction model in the GPT-n series, created by OpenAI™ of San Francisco, California. GPT-4 is an autoregressive language model that uses deep learning to produce human-like text. GPT-4 has been pre-trained on a vast amount of text from the open Internet. While GPT-4 is provided as an example, it should be understood that the generative language model may be any generative language model, including past and future generations of GPT, as well as other large language models, such as any of the Claude family of large language models (e.g., Claude 3 Opus) developed by Anthropic PBC of San Francisco, California, the Falcon large language model (e.g., Falcon 180B) released by the United Arab Emirates'Technology Innovation Institute (TII), the Large Language Model Meta AI (LLaMA) model (e.g., LLaMA 2) released by Meta AI of New York, New York, the Gemini model developed by Google DeepMind of London, United Kingdom, the Mistral family of models released by Mistral AI of Paris, France, and the like. Alternatively or additionally, the generative language model may comprise or consist of a code-completion model that is trained to produce source code, data structures represented in a markup language (e.g., XML, HTML, etc.) or other format, and/or the like. In any case, a pre-trained generative language model may used as a base model that is fine-tuned for the intended task of generating the response (i.e., indicating the impact of adding an integration process 160 to a runtime engine 145), to produce generative model 320A.

Module 345 may format the response, output by generative model 320A, so that it can be displayed in the graphical user interface of user interface 150. In particular, module 345 may generate a dialog frame, comprising the text of the response, or textual elements otherwise derived from the response, in a visual, easy-to-understand format. For example, the dialog frame may highlight any potential errors, identified in the response, and provide a natural-language expression of the overall impact described in the response. In an embodiment in which generative model 320A does not output a natural-language response or outputs a natural-language response that is coarse or verbose, module 345 may input the response from generative model 320A into another generative model, such as a generative language model, to summarize the response from generative model 320A in natural language or otherwise transform the response from generative model 320A into a more suitable (e.g., digestible) format for the user.

Module 350 may display the formatted output, produced by module 345, in the graphical user interface of user interface 150. In particular, module 350 may display the dialog frame, generated by module 345, within or as an overlay on the current screen being provided to the user (e.g., the screen comprising the virtual canvas on which integration process 160 was constructed). Thus, the user may review and easily comprehend the impact that adding integration process 160 to runtime engine 145 will have, including any potential errors that may result.

In an embodiment, the formatted output, produced by module 345 and displayed in the graphical user interface, may comprise an input to activate the impact-mitigation tool, whenever the response indicates that there is an impact. For example, the dialog frame, generated by module 345 and displayed by module 350, may comprise an input that activates the impact-mitigation tool. However, in the event that the response indicates that there is no negative impact, the dialog frame may indicate that there is no negative impact and may exclude the input for activating the impact-mitigation tool, since impact mitigation is not necessary.

Module 360 may activate the impact-mitigation tool. In particular, the impact-mitigation tool may be triggered from the graphical user interface within user interface 150. For example, as discussed above, the formatted output of the impact-prediction tool may comprise an input that, when selected by a user, activates the impact-mitigation tool. Thus, after executing the impact-prediction tool, the user may select the input, within the graphical user interface, that triggers module 360, which activates the impact mitigation for the constructed integration process 160. Alternatively, the impact-mitigation tool may be activated automatically after completion of the impact-prediction tool, or may be activated in response to another trigger.

Module 365 may retrieve integration data for the integration process 160 and runtime data for the runtime engine 145 that are the subjects of the impact mitigation. It should be understood that this integration process 160 and runtime engine 145 are the same integration process 160 and runtime engine 145, respectively, that were the subject of the impact prediction. Thus, again, the integration data may comprise the configuration of the integration process 160, as well as the integration load acquired by module 330, and the runtime data may comprise the configuration of the runtime engine 145 and the current runtime load for that runtime engine 145. In fact, since the integration data and runtime data, retrieved by module 365, may be identical to the integration data and runtime data retrieved by modules 330 and 335, module 365 may simply reuse these data (i.e., without having to re-retrieve the data).

From this point, the impact-mitigation tool may utilize the same RAG architecture as the impact-prediction tool, with retrieval-based and generation-based components. Thus, any description of the retrieval-based component and generation-based component of the impact-prediction tool applies equally to the retrieval-based component and generation-based component of the impact-mitigation tool. In an embodiment, the only difference(s) between the two tools may be the prompt that is generated for the generation-based component and/or the generative model 320 that is used for the generation-based component.

The retrieval-based component of the impact-mitigation tool may be identical to the retrieval-based component of the impact-prediction tool, except that the associated information that is retrieved for each matching embedding vector should include the modification history, in addition to or instead of the execution history. In a preferred embodiment, the impact-prediction tool and the impact-mitigation tool share the retrieval-based component, such that the search of vector database 315 is only performed once for both tools, and the associated execution history and modification history are retrieved for the matching embedding vectors. In this embodiment, module 365 may be omitted, since the necessary information, including the execution and modification history, will already have been retrieved by module 335, or else module 365 may simply represent the reuse of these previously retrieved data.

In the generation-based component, server application 112 applies generative model 320B to the associated information retrieved for each matching embedding vector, including the modification history associated with each matching embedding vector. Like generative model 320A, generative model 320B may be a generative language model, such as a large language model. In an embodiment, generative model 320A and generative model 320B are the same generative model. In an alternative embodiment, generative model 320A and generative model 320B are separate and distinct generative models. However, even in this case, generative model 320B may share a base model with generative model 320A, but may be fine-tuned for the specific task of generating modifications to the configuration of an integration process 160 and/or runtime engine 145 to mitigate the impact of the addition of integration process 160 to runtime engine 145.

As in module 340, module 370 may generate the prompt for generative model 320B based on the result of the search of vector database 315 in the retrieval-based component. The prompt may be generated by inserting relevant data consisting of, comprising, or otherwise derived from the retrieved information that is associated with each matching embedding vector, including at least a portion of the modification history, into a predefined template. The predefined template may comprise a pre-conversation and/or post-conversation, which provide context and/or instructions for generative model 320B, and one or more placeholders into which the relevant data are inserted. The pre-conversation and/or post-conversation may define the role of generative model 320B, which may include instructing generative model 320B to determine at least one modification to integration process 160 and/or runtime engine 145 that mitigates the impact of adding integration process 160 to runtime engine 145, based on the relevant data, which may include a representation of load and/or modification history for each of one or more integration processes 160 and/or runtimes 145 that have similar configurations to the integration process 160 and/or runtime 145, respectively, that are the subject of the impact mitigation. The pre-conversation and/or post-conversation may also define an output format for generative model 320B (e.g., a list structure, a hierarchical structure, a markup-language structure, etc.), and/or perform other functions. Generative model 320B may return a response that provides a list of one or more modifications to the configuration of integration process 160 and/or runtime engine 145. It should be understood that, in some cases, model 320B may be unable to determine any resolution, in which case, the response from generative model 320B may indicate that there is no known resolution.

When the response from generative model 320B comprises a plurality of modifications, the modifications may be ranked (e.g., by generative model 320B or other mechanism), with modifications that are more likely to mitigate the impact ranked higher than modifications that are less likely to mitigate the impact. For instance, each modification may be assigned a confidence value and the modifications may be ranked according to their respective confidence values. The confidence values or other ranking metric may be determined using a weighted scoring model, machine-learning classification, ensemble method, sensitivity analysis, feedback loop/continuous learning, statistical significance testing, or other methodology.

Module 375 may format the response, output by generative model 320B, so that it can be displayed in the graphical user interface of user interface 150. In particular, module 375 may generate a dialog frame, comprising the text of the response, or textual elements otherwise derived from the response, in a visual, easy-to-understand format. For example, the dialog frame may list any modifications to the configuration of integration process 160 and/or runtime engine 145, identified in the response. The modifications in the list may be ordered according to their respective rankings, with higher ranked modifications listed above lower ranked modifications. Each modification in the list may be expandable and collapsible, such that the user may expand a collapsed modification in order to view additional information about that modification (e.g., confidence value, value change for each modified parameter, rationale for the modification, etc.), and collapse an expanded modification in order to hide the additional information about that modification. In an embodiment in which generative model 320B does not output a natural-language response or outputs a natural-language response that is coarse or verbose, module 345 may input the response from generative model 320A into another generative model, such as a generative language model, to summarize the response from generative model 320B in natural language or otherwise transform the response from generative model 320B into a more suitable format for the user.

Module 380 may display the formatted output, produced by module 375, in the graphical user interface of user interface 150. In particular, module 380 may display the dialog frame, generated by module 375, within or as an overlay on the current screen being provided to the user (e.g., the screen comprising the virtual canvas on which integration process 160 was constructed). Thus, the user may review and easily comprehend the proposed modifications to integration process 160 and/or runtime engine 145. In an embodiment, the dialog frame may be visually merged with the dialog frame generated for the impact prediction, such that the user can view the impact with the proposed modifications for mitigating that impact.

In an embodiment, the formatted output, produced by module 345 and displayed in the graphical user interface, may comprise an input to activate a resolution, comprising one or more of the proposed modifications (e.g., all of the proposed modifications, a selected subset of the proposed modifications, etc.). For example, the dialog frame, generated by module 375 and displayed by module 380, may comprise an input that, when selected, implements the resolution.

When the resolution comprises a plurality of modifications, the user may be provided the option to select all of the modifications or any subset of the modifications. For example, each modification may be associated with an input (e.g., checkbox) that enables the user to select that modification. Then, when the user selects the input to activate the resolution, all of the selected modifications will be included in the resolution, whereas none of the unselected modifications will be included in the resolution. Thus, the user can easily implement all of the modifications or any desired subset of the modifications.

Module 385 may activate the resolution. In particular, the resolution may be triggered from the graphical user interface within user interface 150. For example, as discussed above, the formatted output of the impact-mitigation tool may comprise an input that, when selected by a user, activates the resolution (e.g., consisting of the selected modification(s)). Thus, after executing the impact-mitigation tool, the user may select the input (e.g., after selecting one or more of the proposed modifications via one or more other inputs), within the graphical user interface, that triggers module 385, which activates module 390.

Module 390 may modify the integration process 160 and/or runtime engine 145 that were the subject of the impact mitigation, according to the proposed modifications that were listed in the formatted output of module 380 and/or selected by the user. A modification may include, without limitation, changing the structure of integration process 160 (e.g., adding a step, deleting a step, adding a connection, deleting a connection, etc.), changing the value of each of one or more configurable parameters of integration process 160 (e.g., changing the value of a configurable parameter of a step in integration process 160 or for integration process 160 as a whole, changing the execution method of integration process 160, changing the execution frequency of integration process 160, etc.), changing the structure of runtime engine 145 (e.g., increasing the amount of allocated processing power, memory, disk space, bandwidth, and/or other computation resource), and/or the like. In an embodiment, module 390 implements the resolution automatically (i.e., without user intervention), once the resolution has been activated by module 385. Alternatively, if module 390 does not have the ability to automatically implement a resolution, module 390 may instead instruct the user on how to implement the resolution, for example, by displaying a set of instructions (e.g., list of steps) to the user within the graphical user interface and/or providing contact information for technical support.

### 4. Process

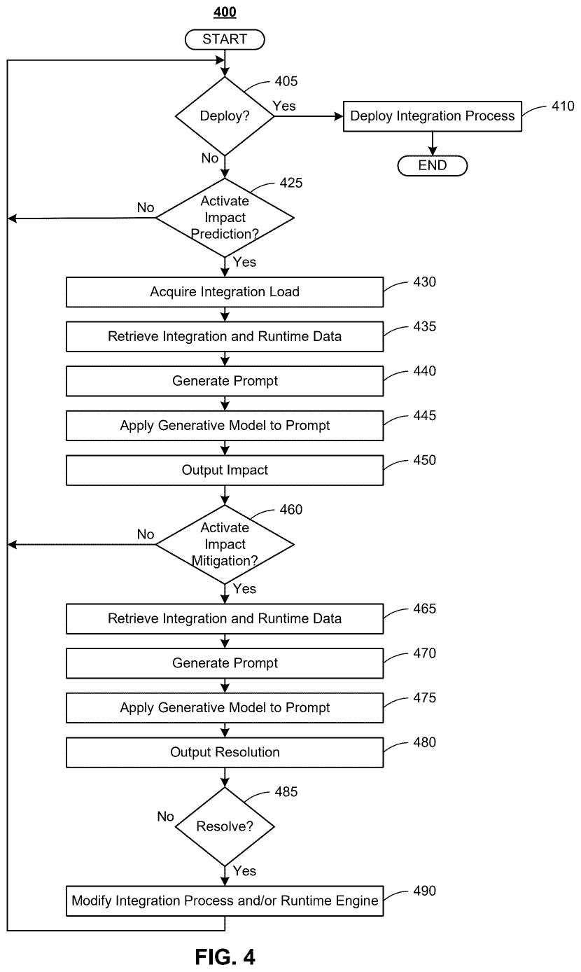

FIG. 4 illustrates a process 400 for AI-powered iPaaS runtime impact prediction and mitigation, according to an embodiment. Process 400 may be implemented in server application 112. While process 400 is illustrated with a certain arrangement and ordering of subprocesses, process 400 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order. Ideally, process 400 is triggered at a point before an integration process 160 has been deployed, such as during the design phase and/or at the point that integration process 160 is about to be deployed.

Subprocess 405 may determine whether or not to deploy integration process 160. For example, the user may construct integration process 160 within a graphical user interface of user interface 150 (e.g., using a virtual canvas as discussed elsewhere herein). After completing the construction of integration process 160, the user may face the decision of whether or not to deploy integration process 160 to a runtime engine 145 in a production environment of integration environment 140. For example, the graphical user interface may comprise one or more inputs for selecting a runtime engine 145 and deploying integration process 160 to the selected runtime engine 145. When determining to deploy integration process 160 (i.e., “Yes” in subprocess 405), for instance, because the user selected the input for deploying integration process 160, process 405 may proceed to subprocess 410. Otherwise, for as long as it is not determined to deploy integration process 160 (i.e., “No” in subprocess 405), for instance, because the user has not yet selected the input for deploying integration process 160, process 405 may proceed to subprocess 425.

Subprocess 410 may deploy integration process 160 to the selected runtime engine 145. In particular, subprocess 410 may convert integration process 160, including all steps in integration process 160 and their configurations, into corresponding executable code. This executable code may then be loaded into runtime engine 145 to be executed, according to the associated runtime configuration, which may include an execution method and/or frequency, along with any other integration processes 160 already executing in runtime engine 145.

Subprocess 425, which may be implemented by module 325, may determine whether or not to activate the impact prediction. In particular, the graphical user interface may comprise an input for activating the impact-prediction tool. Before making the decision of whether or not to deploy integration process 160, the user may wish to assess the impact that integration process 160 will have on runtime engine 145. In this case, the user may select the input to activate the impact-prediction tool, which predicts the impact that integration process 160 will have on runtime engine 145. When determining to activate the impact prediction (i.e., “Yes” in subprocess 425), process 400 may proceed to subprocess 430. Otherwise, when not determining to activate the impact-prediction tool (i.e., “No” in subprocess 425), process 400 may return to subprocess 405 to await deployment of integration process 160 or activation of the impact-prediction tool.

Subprocesses 430 and 435 may acquire integration data for integration process 160 and runtime data for runtime engine 145. The integration data may comprise an integration configuration and integration load for integration process 160, and the runtime data may comprise a runtime configuration and runtime load for runtime engine 145, as discussed in greater detail elsewhere herein.

It should be understood that, at this point, the actual integration load may not be fully known for integration process 160, since integration process 160 has not yet been deployed. Thus, subprocess 430, which may be implemented by module 330, may acquire the integration load from the user. In particular, subprocess 430 may prompt the user, via a dialog frame of the graphical user interface, to enter details about the integration load via one or more inputs in the dialog frame. In a preferred embodiment, the inputs are textboxes into which the user may input natural-language text. In this case, the natural-language text is converted into discrete and actionable fields values of the integration load using natural-language processing, such as a generative language model, as described in greater detail elsewhere herein. This makes it easier and more intuitive for users, especially novice users, to provide the required information. Subprocess 430 may also acquire the identity of the specific runtime engine 145 to which integration process 160 is to be added.

Subprocess 435, which may be implemented by module 335, may retrieve integration and runtime data, before, after, or in parallel with subprocess 430. In particular, subprocess 435 may retrieve the integration configuration of integration process 160, which the user may have recently constructed within the graphical user interface, and the runtime configuration and runtime load of the specific runtime engine 145 to which integration process 160 is to be added (e.g., as acquired in subprocess 430). These integration and runtime data may be previously stored in database 114 or acquired on demand.

In an embodiment that uses the RAG architecture, subprocess 435 may additionally retrieve one or more embedding vectors from vector database 315. In particular, subprocess 435 may generate at least one embedding vector from the integration data and runtime data, and then search vector database 315 for one or more matching embedding vectors that match the at least one embedding vector, according to a similarity metric, as discussed elsewhere herein. Again, vector database 315 may comprise a plurality of embedding vectors, and each of the plurality of embedding vectors may represent a position of a past entity in a multi-dimensional vector space (e.g., comprising at least one-hundred dimensions). Depending on the design, the past entity may be a historical integration process 160, a historical runtime engine 145, or a combination of a historical integration process 160 and a historical runtime engine 145 (e.g., a historical integration process 160 executing within a historical runtime engine 145). As discussed elsewhere herein, the plurality of vector embeddings may be derived from crowd-sourced historical data 305 using vector embedding model 310. Thus, it should be understood that vector database 315 may comprise thousands, tens of thousands, hundreds of thousands, millions, tens of millions, hundreds of millions, billions, tens of billions, hundreds of billions, or more of embedding vectors. Subprocess 335 may retrieve information associated with the matching embedding vector(s), if any, including execution histories and/or modification histories of the integration process(es) 160 and/or runtime engine(s) 145 represented by those matching embedding vector(s).

Subprocess 440, which may be implemented by module 340, may generate a prompt based on the integration data and runtime data acquired by subprocesses 430 and 435, including the integration configuration and/or integration load of integration process 160, and/or the runtime configuration and runtime load of runtime engine 145. In particular, subprocess 440 may generate the prompt by deriving relevant data from the integration data, the runtime data, and/or the information associated with the matching embedding vector(s), if any, from vector database 315, and incorporating the relevant data into a template representing a query (e.g., comprising pre-conversation and/or post-conversation) to generative model 320A, as discussed elsewhere herein. Essentially, the prompt may instruct generative model 320A to, given the execution history(ies) associated with the matching embedding vector(s), which represent similar integration process(es) 160 executing in similar runtime engine(s) 145, predict what the impact will be of adding the integration process 160, which is the subject of the impact prediction, to the runtime engine 145, which is the subject of the impact prediction. The prompt may be expressed in natural language.

Subprocess 445 may apply generative model 320A to the prompt that was generated by subprocess 440, to generate a response. In particular, the prompt may be input to generative model 320A via a call to a function of an application programming interface of generative model 320A. Generative model 320A may return the response, which comprises or otherwise indicates the impact to runtime engine 145 of adding integration process 160 to runtime engine 145. The response may be in natural language. The impact, indicated in the response, may comprise one or more potential errors that are likely to occur if integration process 160 is added to runtime engine 145 and/or an overall impact of adding integration process 160 to runtime engine 145.

Subprocess 450, which may be implemented by module 350, may output the impact. The impact may be output to the graphical user interface, another module of server application 112, and/or another system (e.g., a third-party system 170). However, in a contemplated embodiment, a visual representation of the impact is output to the graphical user interface for review by the user. For instance, a dialog frame may be generated and displayed within the graphical user interface. The dialog frame may provide a visual representation of the impact, provided in the response, including the overall impact and one or more potential errors, if any. The dialog frame may also comprise an input for activating the impact-mitigation tool.

Subprocess 460, which may be implemented by module 360, may determine whether or not to activate the impact mitigation. In particular, the graphical user interface may comprise an input for activating the impact-mitigation tool, as discussed above. Before making the decision of whether or not to deploy integration process 160, the user may wish to mitigate any impact that may result from adding integration process 160 to runtime engine 145, as determined by the impact-prediction tool, represented by subprocesses 430-450. In this case, after performance of the impact prediction, the user may select the input to activate the impact-mitigation tool, which determines a resolution to mitigate the impact that integration process 160 will have on runtime engine 145. When determining to activate the impact mitigation (i.e., “Yes” in subprocess 460), process 400 may proceed to subprocess 465. Otherwise, when not determining to activate the impact-mitigation tool (i.e., “No” in subprocess 460), process 400 may return to subprocess 405 to await deployment of integration process 160 or activation of the impact-prediction tool and/or impact-mitigation tool.

Subprocess 465, which may be implemented by module 365, may retrieve integration and runtime data. In particular, subprocess 465 may retrieve the integration configuration and integration load of integration process 160, and the runtime configuration and runtime load of the specific runtime engine 145 to which integration process 160 is to be added. These integration and runtime data may be previously stored in database 114 or acquired on demand. It should be understood that subprocess 465 may retrieve the same data that are acquired in subprocesses 430 and 435 of the integration-prediction tool. Accordingly, subprocess 465 may simply re-access the data that were already acquired in subprocess 435, including the information associated with any matching embedding vectors in vector database 315. Alternatively, subprocess 465 could reacquire these data in the same or similar manner, or in a different manner.

Subprocess 470, which may be implemented by module 370, may generate a prompt based on the integration data and runtime data acquired by subprocess 465, including the integration configuration and/or integration load of integration process 160, the runtime configuration and runtime load of runtime engine 145, and/or the information associated with the matching embedding vector(s), if any, from vector database 315. In particular, subprocess 470 may generate the prompt by deriving relevant data from the integration data, the runtime data, and/or the information associated with the matching embedding vector(s), if any, from vector database 315, and incorporating the relevant data into a template representing a query (e.g., comprising pre-conversation and/or post-conversation) to generative model 320B, as discussed elsewhere herein. Essentially, the prompt may instruct generative model 320B to, given the execution history(ies) and modification history(ies) associated with the matching embedding vector(s), which represent similar integration process(es) 160 executing in similar runtime engine(s) 145, determine a resolution that mitigates the impact of adding the integration process 160 to the runtime engine 145, as predicted by the impact-prediction tool. The prompt may be expressed in natural language.

Subprocess 475 may apply generative model 320B to the prompt that was generated by subprocess 470, to generate a response. In particular, the prompt may be input to generative model 320B via a call to a function of an application programming interface of generative model 320B. Generative model 320B may return the response, which indicates a resolution (e.g., comprising one or more modifications) for mitigating the impact of adding integration process 160 to runtime engine 145. The response may be in natural language. The resolution, indicated in the response, may comprise one or more modifications to integration process 160 (e.g., to a configuration of integration process 160) and/or runtime engine 145 (e.g., to a configuration of runtime engine 145). Generative model 320B may be the same as or different from generative model 320A.

Subprocess 480, which may be implemented by module 380, may output the resolution. The resolution may be output to the graphical user interface, another module of server application 112, and/or another system (e.g., a third-party system 170). However, in a contemplated embodiment, a visual representation of the resolution is output to the graphical user interface for review by the user. For instance, a dialog frame may be generated and displayed within the graphical user interface. This dialog frame may be the same as or different from the dialog frame generated in subprocess 450 for the impact-prediction tool. The dialog frame may provide a visual representation of the resolution, provided in the response, including a list of one or more modifications to integration process 160 and/or runtime engine 145. The dialog frame may also comprise an input for activating the resolution.

Subprocess 485, which may be implemented by module 385, may determine whether or not to activate the resolution, output by the impact-mitigation tool in subprocess 480. In particular, the graphical user interface may comprise an input for activating or implementing the resolution, as discussed above. Before making the decision of whether or not to activate the resolution, the user may review the list of modification(s), representing the resolution, as determined by the impact-mitigation tool, represented by subprocesses 465-480, and/or select one or more of the modifications to include in the resolution. The user may then select the input to activate the resolution. When determining to activate the resolution (i.e., “Yes” in subprocess 485), process 400 may proceed to subprocess 490. Otherwise, when not determining to activate the resolution (i.e., “No” in subprocess 485), process 400 may return to subprocess 405 to await deployment of integration process 160 or activation of the impact-prediction tool and/or impact-mitigation tool.

Subprocess 490, which may be implemented by module 390, may implement the resolution, output by the impact-mitigation tool, including any modifications (e.g., selected modifications) to integration process 160 and/or runtime engine 145. Such a modification may include a change to the structure of integration process 160, a change to the value of each of one or more parameters of integration process 160, a change to the execution method or frequency of integration process 160, a change to the structure of runtime engine 145 (e.g., increasing the amount of allocated processing power, memory, disk space, bandwidth, and/or other computational resources), and/or the like. In other words, the impact mitigation may comprise modifying one or both of integration process 160 and runtime engine 145, according to the resolution. After implementing the resolution, process 400 may return to subprocess 405 to await deployment of integration process 160 or activation of the impact-prediction tool and/or impact-mitigation tool.

Embodiments of process 400 leverage artificial intelligence, including machine learning, to analyze relevant data, derived from an integration configuration, expected integration load, runtime configuration, and/or runtime load, in order to predict the impact of adding a specific integration process to a specific runtime engine, based on historical integration and runtime data (e.g., the execution histories of historical integration processes 160 and/or runtime engines 145). Additional or alternative embodiments of process 400 leverage artificial intelligence, including machine learning, to analyze the same or similar relevant data, in order to determine a resolution that mitigates the impact of adding a specific integration process to a specific runtime engine, based on historical integration and runtime data (e.g., the resolution histories of historical integration processes 160 and/or runtime engines 145). At least a subset of the necessary information may be provided to and collected from the user using easy-to-understand and intuitive natural-language communications.

With the knowledge provided by the impact-prediction tool and/or impact-mitigation tool, users can implement modifications to their integration processes 160 and/or runtime engines 145, prior to deployment, in order to proactively avoid the predicted impacts, instead of reacting to those impacts post-deployment. As a result, integration developers can have greater confidence in their integration processes, at the time of deployment, and will experience fewer runtime issues after deployment.

### 5. Graphical User Interface

Boomi® provides an iPaaS platform that has revolutionized the integration/middleware space with a drag-and-drop graphical user interface that eliminates the need for custom code in the construction of integration processes 160. In particular, the graphical user interface comprises a virtual canvas over which a user may drag and drop shapes, representing steps that perform specific functions, and connect the shapes to define data flows between their respective functions. Thus, the user may intuitively construct an integration process 160 by simply adding, configuring, and connecting shapes in an intuitive manner, within a low-code integration environment.

However, prior to deployment, developers are often uncertain about how the integration processes 160 that they construct will impact the runtime engine 145 to which the integration process 160 will be deployed. This is especially true for novice users. Accordingly, disclosed embodiments provide an easy-to-use, intuitive graphical user interface for predicting and/or mitigating the impact of integration process 160 on runtime engine 145. This graphical user interface may be used by both novice and expert developers to efficiently troubleshoot their integration processes 160 prior to deployment. An embodiment of this graphical user interface is described below.

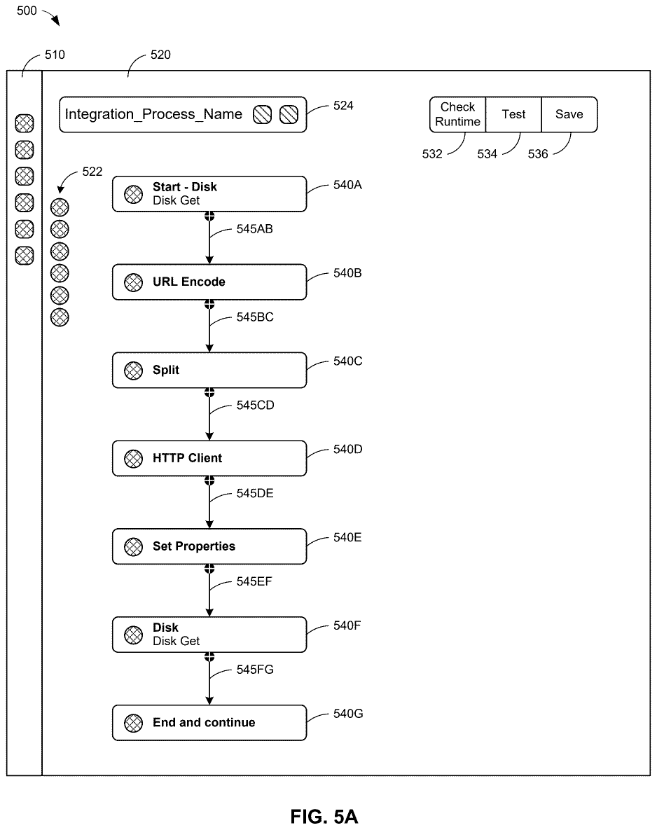

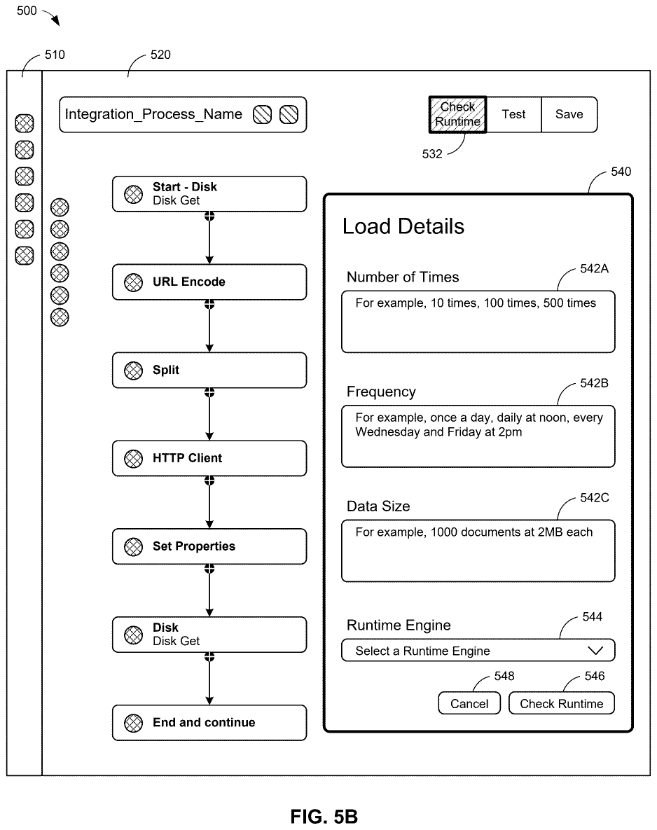

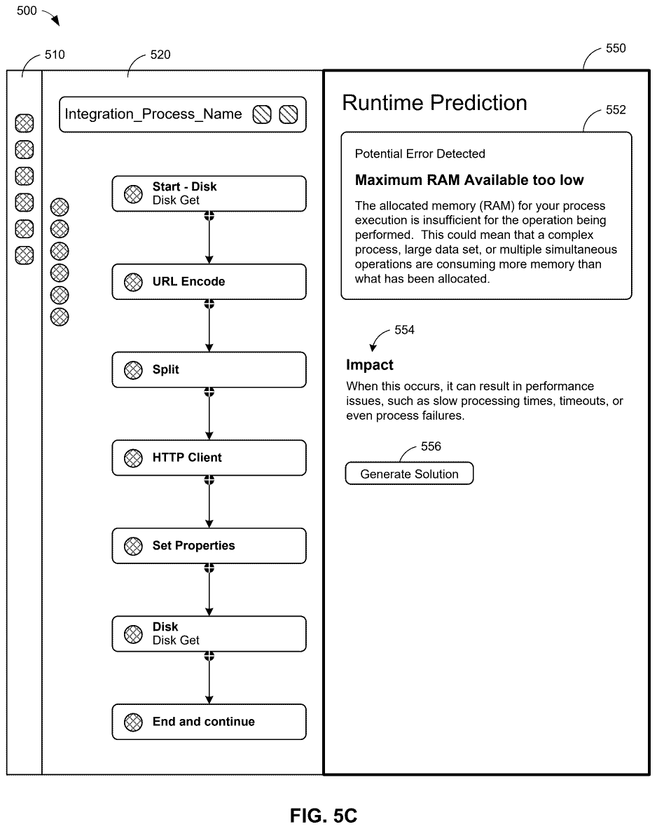

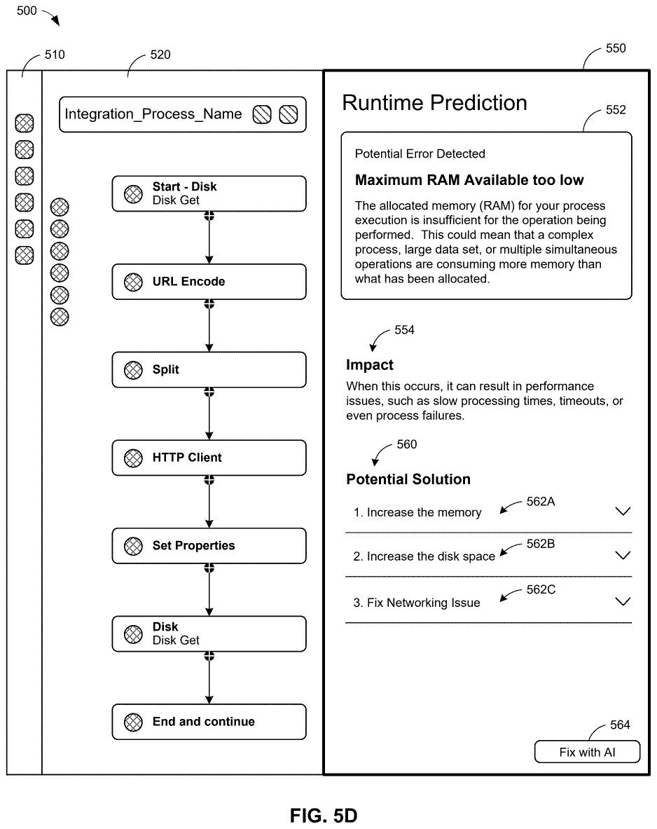

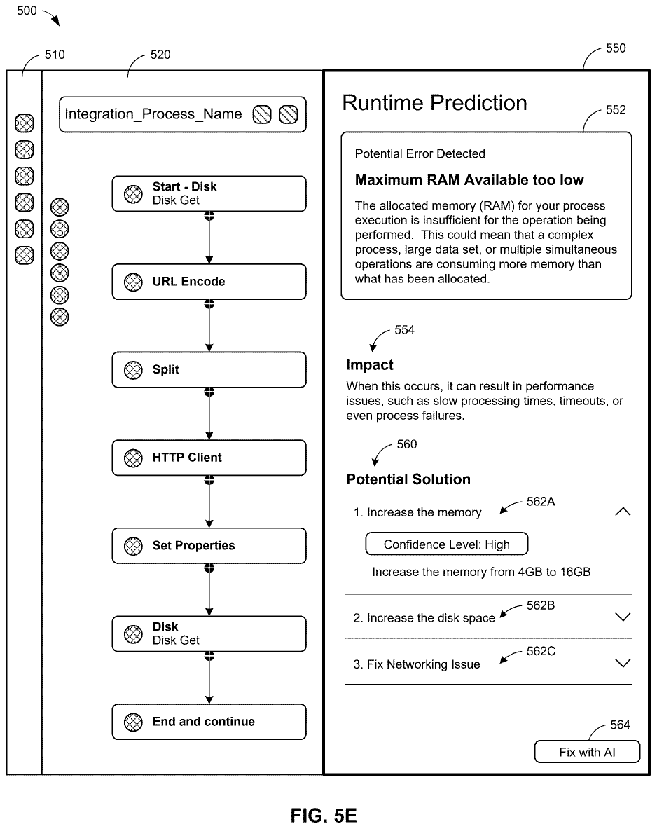

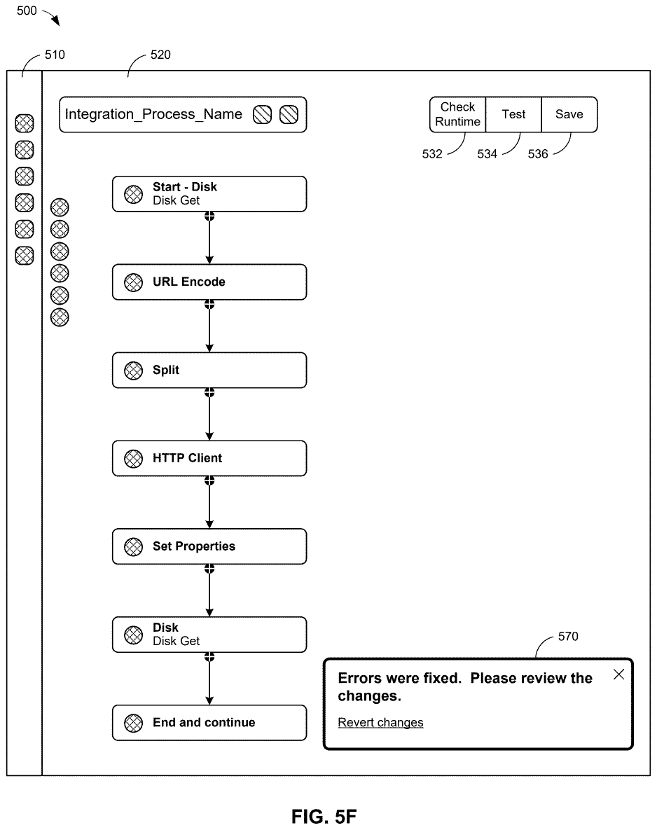

FIG. 5A illustrates an example graphical user interface 500 that may be used to construct an integration process 160, according to an embodiment. Graphical user interface 500 may be provided by user interface 150 of server application 112. In the illustrated example, graphical user interface 500 comprises a navigation bar 510 and a virtual canvas 520. Virtual canvas 520 enables a user to drag and drop representations (i.e., “shapes”) of steps at positions within an integration process 160 to be constructed, and connect these representations to form one or more lineages (i.e., paths or sub-paths).

Virtual canvas 520 may comprise a shape palette 522, from which new shapes can be dragged and dropped on virtual canvas 520, and a header 524 which may comprise information (e.g., name) for the integration process 160 as a whole. In addition, virtual canvas 520 may comprise a review input 532 for activating the disclosed impact-prediction tool, a test input 534 for testing integration process 160 (e.g., executing integration process 160 in a test environment), and a save input 536 for saving integration process 160 in the current configuration.

In the illustrated example, a user has constructed an integration process 160 with shapes 540A, 540B, 540C, 540D, 540E, 540F, and 540G, which each represents a step in integration process 160. Each of shapes 540 is connected to at least one adjacent shape 540 by a connection 545. In the illustrated example, shape 540A is connected to shape 540B by connection 545AB, shape 540B is connected to shape 540C by connection 545BC, shape 540C is connected to shape 540D by connection 545CD, shape 540D is connected to shape 540E by connection 545DE, shape 540E is connected to shape 540F by connection 545EF, and shape 540F is connected to shape 540G by connection 545FG. Since there are no branches, integration process 160 consists of a single path, and therefore, a single start-to-end lineage. However, if sub-paths are considered, integration process 160 comprises a plurality of other lineages representing sub-paths.

FIG. 5B illustrates graphical user interface 500, after a user has selected review input 532, according to an embodiment. Responsively, graphical user interface 500 has been updated to display a dialog frame 540, next to the representation of integration process 160. Dialog frame 540 represents an embodiment of module 330 and subprocess 430, which acquire the integration load from the user. In this example, dialog frame 540 comprises an input 542A for inputting a number of times that integration process 160 is expected to be executed (e.g., ten times, one-hundred times, five-hundred times, etc.), an input 542B for inputting a frequency at which integration process 160 is to be executed (e.g., once a day, daily at noon, every Wednesday and Friday at 2 pm, etc.), and an input 542C for inputting a data size (e.g., number of documents and size of each document). Each of inputs 542A, 542B, and 542C may comprise a textbox that accepts natural language as an input, providing the user with flexibility in how to enter the details of the integration load. Dialog frame 540 may also comprise an input 544 for selecting the runtime engine 145 to which integration process 160 is to be deployed, from among a set of available runtime engines 145, an input 546 for activating the impact-prediction tool, and an input 548 for canceling the review.

FIG. 5C illustrates graphical user interface 500, after a user has selected input 546, according to an embodiment. The selection of input 546 activates the impact-prediction tool. As discussed elsewhere herein, matching embedding vector(s) may be retrieved, based on the integration and runtime data, and a prompt may be generated and input to generative model 320A to produce a response, comprising an impact of adding integration process 160 to runtime engine 145 (e.g., as selected via input 544). Module 345 may generate a dialog frame 550, and module 350 may display dialog frame 550 in graphical user interface 500.

Dialog frame 550 comprises a visual representation of the impact, predicted by generative model 320A. This visual representation may comprise a description 552 of each potential error included in the response of generative model 320A, and a description 554 of the overall impact that the potential error(s) may have on the selected runtime engine 145. Dialog frame 550 may also comprise an input 556 for activating the impact-mitigation tool.

FIG. 5D illustrates graphical user interface 500, after a user has selected input 556, according to an embodiment. The selection of input 556 activates the impact-mitigation tool. As discussed elsewhere herein, matching embedding vector(s) may be retrieved, based on the integration and runtime data, and a prompt may be generated and input to generative model 320B to produce a response, comprising a resolution for mitigating the impact of adding integration process 160 to runtime engine 145. Module 375 may generate a dialog frame 560, and module 380 may display dialog frame 560 in graphical user interface 500. In the illustrated embodiment, dialog frame 560 is added to dialog frame 550.

Dialog frame 560 comprises a visual representation of the resolution, determined by generative model 320B. The visual representation of the resolution may comprise a list of one or more modifications, representing the resolution. In the illustrated example, the resolution comprises three proposed modifications, consisting of a modification, represented by visual representation 562A, to increase memory allocated to runtime engine 145, a modification, represented by visual representation 562B, to increase the disk space allocated to runtime engine 145, and a modification, represented by visual representation 562C, to fix a networking issue. The visual representation 562 of each modification may be expandable to provide details about the respective modification and collapsible to hide the details about the respective modification.

FIG. 5E illustrates graphical user interface 500, after a user has expanded visual representation 562A, according to an embodiment. In response to the expansion of visual representation 562A by the user, additional details, about the modification to increase the memory allocated to runtime engine 145, are displayed. These additional details comprise a confidence level (e.g., low, medium, or high) and a specific recommended change, which, in the illustrated example, is an increase to the allocated memory, including a specific value of the increase (e.g., from four gigabytes to sixteen gigabytes).

FIG. 5F illustrates graphical user interface 500, after a user has selected input 564, according to an embodiment. In response to selection of input 564, dialog frames 550 and 560 are hidden and dialog frame 570 is displayed. Dialog frame 570 may comprise an indication that the resolution was implemented (e.g., errors were fixed) and/or a prompt to review the modification(s) required by the resolution. Dialog frame 570 may also comprise an input (e.g., link) to revert the modifications (i.e., roll back the modifications), for example, if the user is unhappy or unsatisfied with the resolution following implementation of the resolution.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to, prior to deployment of an integration process to a runtime engine, perform impact prediction comprising:
acquiring integration data for the integration process and runtime data for the runtime engine, wherein the integration data comprise an integration configuration and integration load for the integration process, and wherein the runtime data comprise a runtime configuration and runtime load for the runtime engine;
generating a first prompt based on the integration data and the runtime data;
applying a first generative model to the first prompt to generate a first response comprising an impact to the runtime engine of adding the integration process to the runtime engine; and
outputting a first visual representation of the impact within a graphical user interface.

2. The method of claim 1, wherein the first generative model comprises a large language model.

3. The method of claim 1, further comprising using the at least one hardware processor to, after performing the impact prediction, perform impact mitigation comprising:
generating a second prompt based on the integration data and the runtime data;
applying a second generative model to the second prompt to generate a second response comprising a resolution for the impact; and
outputting a second visual representation of the resolution within the graphical user interface.

4. The method of claim 3, wherein the second generative model comprises a large language model.

5. The method of claim 3, wherein the first generative model and the second generative model are a same model.

6. The method of claim 3, wherein the second visual representation of the resolution comprises a list of one or more modifications to one or both of the integration process or the runtime engine.

7. The method of claim 3, wherein the graphical user interface comprises a first input for activating the impact mitigation, and wherein the impact mitigation is performed in response to selection of the first input.

8. The method of claim 3, wherein the impact mitigation further comprises modifying one or both of the integration process and the runtime engine according to the resolution.

9. The method of claim 8, wherein the graphical user interface comprises a second input for implementing the resolution, and wherein the modification of one or both of the integration process and the runtime engine is performed in response to selection of the second input.

10. The method of claim 9, wherein the modification of one or both of the integration process and the runtime engine comprises modifying a configuration of the runtime engine.

11. The method of claim 10, wherein modifying the configuration of the runtime engine comprises increasing an amount of at least one computational resource allocated to the runtime engine.

12. The method of claim 11, wherein the at least one computational resource comprises one or more of processing power, memory, disk space, or bandwidth.

13. The method of claim 1, wherein generating the first prompt, based on the integration data and the runtime data, comprises:
generating at least one embedding vector from the integration data and the runtime data;
searching a vector database for one or more matching embedding vectors that match the at least one embedding vector, according to a similarity metric, wherein the vector database comprises a plurality of embedding vectors, and wherein each of the plurality of embedding vectors represents a position of a past entity in a multi-dimensional vector space, wherein the past entity is one or both of a historical integration process or a historical runtime.

14. The method of claim 13, wherein the plurality of embedding vectors are generated from crowd-sourced historical data using a vector embedding model.

15. The method of claim 13, wherein the multi-dimensional vector space comprises at least one-hundred dimensions.

16. The method of claim 13, wherein the at least one embedding vector comprises an embedding vector for each lineage in the integration process, wherein each lineage represents a single path through the integration process.

17. The method of claim 1, wherein the first visual representation comprises an overall impact.

18. The method of claim 17, wherein the first visual representation further comprises one or more potential errors.

19. A system comprising:
at least one hardware processor; and
software that is configured to, when executed by the at least one hardware processor, prior to deployment of an integration process to a runtime engine, perform impact prediction comprising
acquiring integration data for the integration process and runtime data for the runtime engine, wherein the integration data comprise an integration configuration and integration load for the integration process, and wherein the runtime data comprise a runtime configuration and runtime load for the runtime engine,
generating a first prompt based on the integration data and the runtime data,
applying a first generative model to the first prompt to generate a first response comprising an impact to the runtime engine of adding the integration process to the runtime engine, and
outputting a first visual representation of the impact within a graphical user interface.

20. A non-transitory computer-readable medium having instructions stored therein, wherein the instructions, when executed by a processor, cause the processor to, prior to deployment of an integration process to a runtime engine, perform impact prediction comprising:
acquiring integration data for the integration process and runtime data for the runtime engine, wherein the integration data comprise an integration configuration and integration load for the integration process, and wherein the runtime data comprise a runtime configuration and runtime load for the runtime engine;
generating a first prompt based on the integration data and the runtime data;
applying a first generative model to the first prompt to generate a first response comprising an impact to the runtime engine of adding the integration process to the runtime engine; and
outputting a first visual representation of the impact within a graphical user interface.
